(19) United States
(12) Patent Application Publication
(10) Pub. No.: US 2008/0217922 A1
(43) Pub. Date: Sep. 11, 2008

(54) Hybrid wind generator process

(76) Inventor: Kevin Chiu, West Hartford, CT (US)

Correspondence Address: KEVIN CHIU, 35 CLAYBAR DR., WEST HARTFORD, CT, 06117, US

(21) Appl. No.: 11/714,924

(22) Filed: Mar. 8, 2007

(51) Int. Cl. F03B 13/00; H02P 9/04

(52) U.S. Cl. 290/54; 290/55; 903/903

(57) ABSTRACT

The present invention includes a process to generate electricity for vehicles by means of harnessing the wind power created with the motion of the vehicle. The motion of the air is transferred to the bottom of the vehicle by an exterior aperture with slanted sides directing the air to a tube. The tube leads the moving air straight to the back of a car right before where the energy sources; batteries and/or fuel tank are located. There is once again another opening for the moving air to shoot out from and spin a mounted turbine blade from the side with a generator which feeds energy to the batteries.

### BACKGROUND OF THE INVENTION

The present invention relates to wind power generators for use in generating electricity in a clean and environmentally healthy way and also to hybrid vehicles such as electrical and fuel powered automobiles to harness the wind motion from the movement of the vehicle in order to create electrical power without the use of charging.

Wind generators today all rely on natural wind power, which is a clean dependable source to rely on. However, weaknesses include the visual impact of these wind turbines to higher population density areas, bird mortalities due to the unconcealed turbine blades, and the fluctuation in wind speed which causes variable power output.

Most hybrid vehicles are designed to use both fuel and electricity, in order to save more fuel to increase gas mileage. However, plug in hybrids rely too much on an external charging output while hybrids that use regenerative brakes only generate enough electrical energy to partially assist the gas engine, therefore not being able to improve fuel consumption significantly.

As a result, there is a need for a process that generates enough electricity to power a hybrid car effectively without the use of charging. There is also a need for a process with wind turbines that create a constant power output without having the dangers of open turbine blades.

### SUMMARY OF THE INVENTION

Therefore, the aspects of the present invention are to provide a wind generating process that avoid the disadvantages described and to use this wind generating process to charge an electrical battery effectively for a hybrid vehicle. By utilizing the kinetic energy from the motion of the vehicle, the wind turbines will have a constant and significant power output. Also, by being concealed beneath the vehicle, the aesthetics will no longer be a problem as well as the turbine blades to birds. Thus, hybrid vehicles equipped with this wind generator will be able to decrease fuel consumption. The general idea of the process is that when the vehicle is in motion, air will pass along and follow through the bottom of the vehicle to spin a mounted blade rotor from the side which generates the electricity needed for the electrical engine.

### DESCRIPTION OF SEVERAL VIEWS OF DRAWINGS

FIG. 1 is an overview of the wind generating process;

FIG. 2 is the underside of a car depicting the wind rotor, the wide aperture leading the air in, and the tube leading the air out;

FIG. 3 is the front view of a car depicting the wide aperture of the wind generating process;

FIG. 4 is the back view of a car depicting the rotor and the tube leading the air out;

FIG. 5A is the side view of a car depicting the wind rotor, the wide aperture leading the air in, and the tube leading the air out;

FIG. 5B is an exploded view of FIG. 5A compromising the wind rotor and tube leading the air out;

FIG. 6A is the perspective view of a car depicting the wind rotor, the wide aperture leading the air in, and the tube leading the air out;

FIG. 6B is an exploded view of FIG. 6A depicting the wide aperture leading the air in.

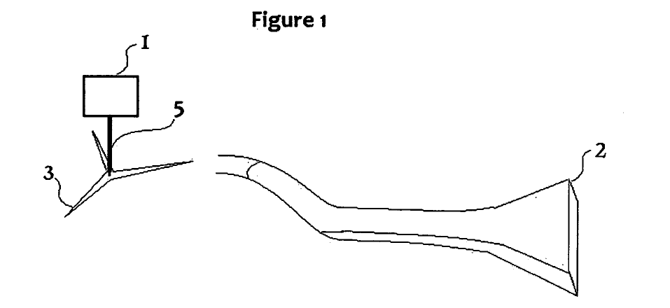

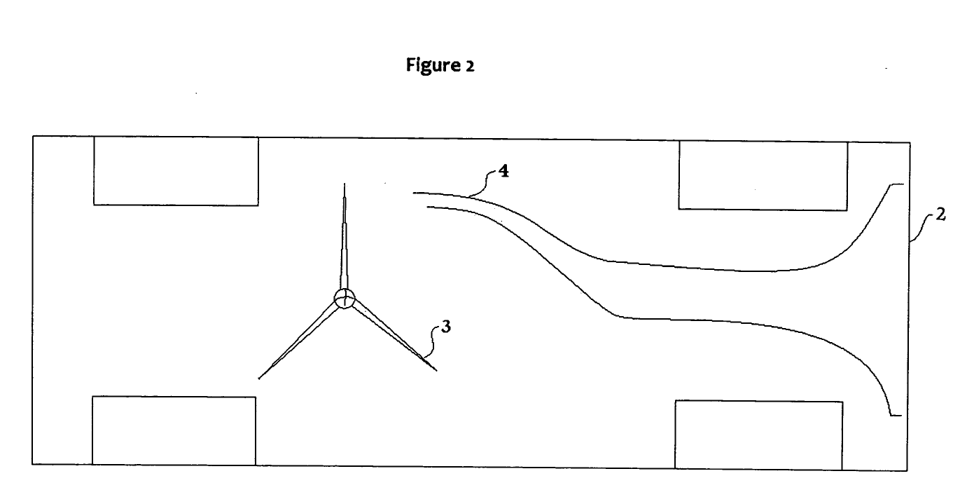

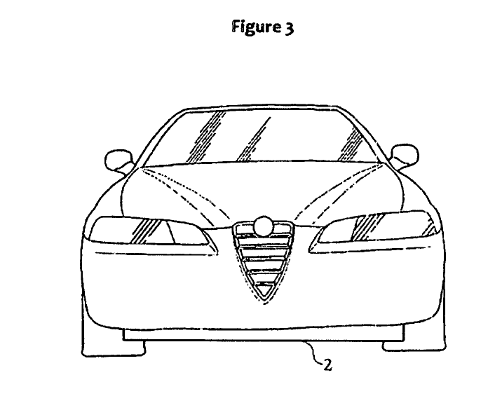

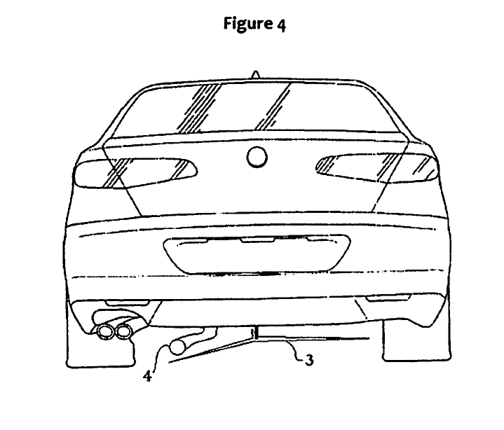

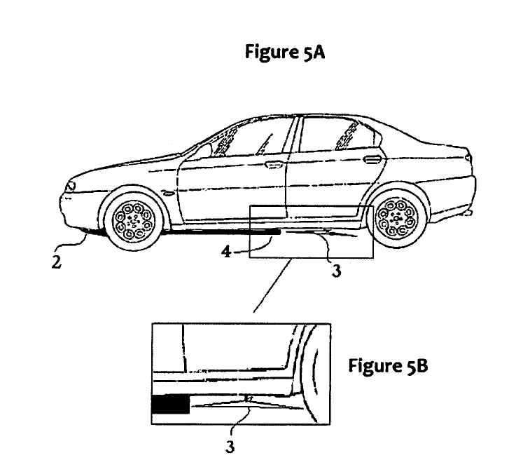

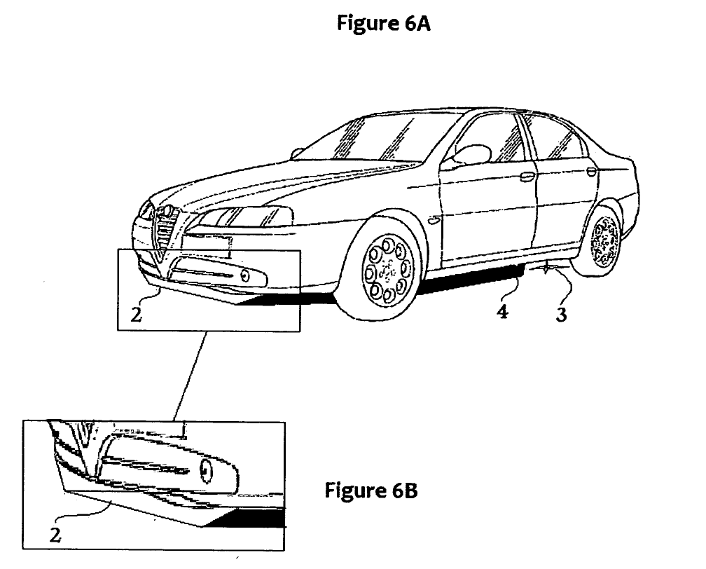

### DETAILED DESCRIPTION OF THE INVENTION

A detailed description of the hybrid wind generating process will now be described. A wind rotor 3 designed to capture the wind from the side is attached to the underside of a car. Above the wind rotor 3 is a generator 1 that is connected to the rotor by a shaft 5. When the wind rotor 3 is spun, the generator 1 produces electricity in order to help charge the batteries in the hybrid vehicle. The process of obtaining the wind to spin the rotor 3 starts from when the vehicle is moving. The air from the motion of the vehicle is transferred to the underside of the car by a wide aperture 2 near the bumper. Note that the aperture 2 needs to be wide enough so that the most air can be obtained and so that any air on the side will not push the rotor 3 in the opposite direction. Through the aperture 2, the tunnel starts narrowing to avoid contact with the wheels. The air reaches a tube 4, which winds its way to the side of the rotor 3. Another opening leads the air out to spin the rotor 3.

I claim:

1. A process to generate electricity through the motion of a vehicle compromising: a wide aperture in the front of a vehicle; a tube that leads to the side of a vehicle; a wind rotor and shaft attached to the underside of a vehicle; and a generator within a vehicle feeding energy to the batteries.
